(19) United States
(12) Patent Application Publication
(10) Pub. No.: US 2016/0173675 A1
(43) Pub. Date: Jun. 16, 2016

(54) IN-VEHICLE MULTIMEDIA SYSTEM CONSIDERING CALL SITUATION AND METHOD FOR CONTROLLING THE SAME

(71) Applicant: HYUNDAI MOTOR COMPANY, Seoul (KR)

(72) Inventor: Chang Woo CHUN, Anyang-si (KR)

(21) Appl. No.: 14/747,973

(22) Filed: Jun. 23, 2015

(30) Foreign Application Priority Data
Dec. 16, 2014 (KR) 10-2014-0180952

(51) Int. Cl. H04M 1/60; H04W 76/02; H04L 29/08

(52) U.S. Cl. CPC H04M 1/6083; H04L 67/12; H04L 67/2842; H04W 76/02

(57) ABSTRACT

Disclosed are a method in which, after occurrence of a call situation during reproduction of content, corresponding content may be again provided to a passenger in an in-vehicle multimedia system so as not to miss the content, and a vehicle for performing the same. A method for controlling reproduction of content in a vehicle includes connecting the vehicle to an external communication terminal, starting reproduction of the content, activating the hands-free function of the external communication terminal during reproduction of the content, performing caching of the content being reproduced according to activation of the hands-free function until the hands-free function is deactivated, temporarily stopping reproduction of the content, and reproducing the cached content when the hands-free function is deactivated.

### CROSS-REFERENCE TO RELATED APPLICATION

This application claims the benefit of Korean Patent Application No. 10-2014-0180952, filed on Dec. 16, 2014, the disclosure of which is hereby incorporated by reference as if fully set forth herein.

### TECHNICAL FIELD

The present disclosure relates to a method in which, after occurrence of a call situation during reproduction of content, corresponding content may be again provided to a passenger in an in-vehicle multimedia system so as not to miss the content, and a vehicle for performing the same.

### BACKGROUND

Recently, a function of reproducing various multimedia content, such as radio broadcasting, digital multimedia broadcasting (DMB), or a multimedia streaming service through the Internet, is being provided. Further, a function of calling during driving through a Bluetooth hands-free function is generally provided now.

However, if a passenger performs a call through the hands-free function during reproduction of multimedia content, the passenger may miss the content output through radio broadcasting or DMB during a calling time.

### SUMMARY

Accordingly, the present disclosure is directed to an in-vehicle multimedia system considering a call situation and a method for controlling the same that substantially obviate one or more problems due to limitations and disadvantages of the related art.

An object of the present disclosure is to provide an in-vehicle multimedia system which may output content in a broadcasting type, missed by a user during a call, subsequently after end of the call, and a method for controlling the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for controlling reproduction of content in a vehicle includes connecting the vehicle to an external communication terminal, starting reproduction of the content, activating the hands-free function of the external communication terminal during reproduction of the content, performing caching of the content being reproduced according to activation of the hands-free function until the hands-free function is deactivated, temporarily stopping reproduction of the content, and reproducing the cached content when the hands-free function is deactivated.

In another aspect of the present disclosure, an in-vehicle content reproduction system includes a wireless communication unit connected to an external communication terminal wirelessly and configured to transmit/receive hands-free related data and a controller configured to, when the hands-free function of the external communication terminal is activated during reproduction of content, perform caching the content being reproduced until the hands-free function is deactivated, temporarily stop reproduction of the content, and reproduce the cached content when the hands-free function is deactivated.

It is to be understood that both the foregoing general description and the following detailed description of the present disclosure are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram exemplarily illustrating the configuration of an in-vehicle AVN system in accordance with one embodiment of the present disclosure;

FIG. 2 is a flowchart exemplarily illustrating a method for controlling multimedia content according to occurrence of a telephone call in an in-vehicle AVN system in accordance with one embodiment of the present disclosure; and

FIG. 3 is a flowchart exemplarily illustrating, in more detail, a method for controlling multimedia content according to occurrence of a telephone call in an in-vehicle AVN system in accordance with one embodiment of the present disclosure.

### DETAILED DESCRIPTION

Reference will now be made in detail to the preferred embodiments of the present disclosure, examples of which are illustrated in the accompanying drawings. In the drawings, the same or similar elements are denoted by the same reference numerals even though they are depicted in different drawings, and a detailed description thereof will be omitted. The suffixes “module” and “unit” in elements used in the description below are given or used together only in consideration of ease in preparation of the specification and do not have distinctive meanings or functions.

In the following description of embodiments of the present disclosure, a detailed description of known functions and configurations incorporated herein will be omitted when it may make the subject matter of the present disclosure rather unclear. Further, the accompanying drawings have been made only for a better understanding of the embodiments of the present disclosure. It will be appreciated that the technical spirit disclosed in the specification is not restricted by the accompanying drawings and includes various modifications, equivalents, and substitutions, without departing from the scope and spirit of the invention as disclosed in the accompanying claims.

One embodiment of the present disclosure proposes that, if a telephone call start event occurs during reproduction of multimedia content, a buffer is assigned according to a type of the corresponding content so that caching is performed and reproduction of the corresponding content is stopped until the call is ended. Further, the embodiment proposes that, when the call event is ended before the capacity of the cached content exceeds the capacity of the assigned buffer, the content cached in the buffer is reproduced and a currently acquired portion of the corresponding content is continuously cached according to the type of the content. If caching is stopped, when reproduction of the cached portion of the content from the reproduction point is finished, a currently acquired portion the content is reproduced. Such a process serves to prevent a user from missing the content received during the calling time. Therefore, stopping of caching of the current acquired content may be continued until user's channel switching or turning-off of a broadcast reception function occurs.

Here, the content type, caching of which is performed, may be content, a reproduction point of which may not be arbitrarily selected, i.e., broadcasting or streaming content. If the content type is streaming content, a reproduction point of which may be selected at all times, or content, such as CD/MP3, reproduction of the content may be temporarily stopped during a call and the content may be automatically reproduced from the stoppage point when the call is ended. Even in case of streaming content, a reproduction point of which may be selected, a designated amount of buffering may be required to resume reproduction of the content after stoppage of reproduction and thus, a designated reproduced portion of the content after the temporary stoppage point may be downloaded during a call.

First, the configuration of an apparatus to perform embodiments of the present disclosure will be described.

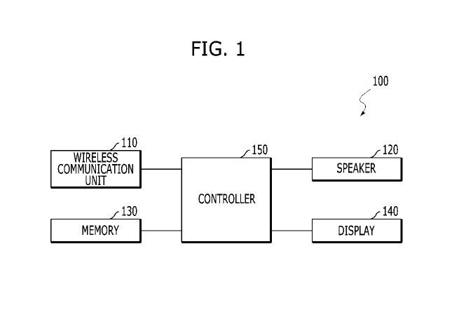

FIG. 1 is a block diagram exemplarily illustrating the configuration of an in-vehicle AVN system in accordance with one embodiment of the present disclosure.

With reference to FIG. 1, an in-vehicle audio video navigation (AVN) system 100 may include a wireless communication unit 110 connected to a communication device, such as a smartphone, through a wireless communication method, such as Bluetooth or Wi-Fi, to exchange image/sound signals with the communication device and to receive digital multimedia broadcasting (DMB)/radio broadcasting/streaming content, a speaker 120 to output multimedia sound, related sound when a navigation function is executed and/or telephone voice of a counterpart when a hands-free function is executed, a memory 130 to store map information for a navigation system, multimedia content, setting information and/or cached data of broadcasting/streaming content in accordance with this embodiment, a display 140 to output map information for the navigation system or image information of multimedia content, and a controller 150 to control the above-described elements and to perform determination and calculation required to implement this embodiment. For example, the controller 150 may control the overall process of establishing a wireless data path with an external device which will use a hands-free function, if a call is performed through the hands-free function during reproduction of multimedia content, stop reproduction of the corresponding content according to the type of the reproduced multimedia content and perform caching, and immediately reproduce the cached content when the call is terminated.

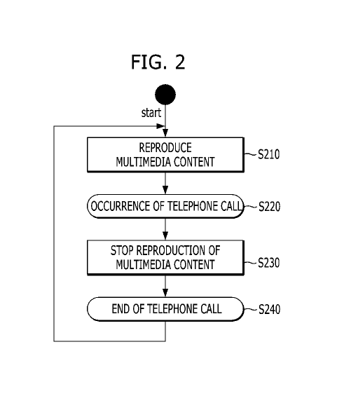

Next, a schematic operating process of the present disclosure will be described with reference to FIG. 2.

FIG. 2 is a flowchart exemplarily illustrating a method for controlling multimedia content according to occurrence of a telephone call in an in-vehicle AVN system in accordance with one embodiment of the present disclosure.

In the following description including FIG. 2, it will be assumed that an external device is a smartphone and pairing between the smartphone and the AVN system is completed so as to provide a hands-free function prior to occurrence of a call. Further, start of a call means start of a call through the hands-free function. Therefore, the AVN system may sense start and end of the call.

With reference to FIG. 2, first, the AVN system reproduces multimedia content (Operation S210). As described above, the multimedia content may be DMB, radio broadcasting, or broadcasting provided in a streaming type through the Internet, content prestored in a memory or a CD/DVD, or streaming content, a reproduction point of which may be selected.

If a telephone call occurs during reproduction of the content and a driver activates the hands-free function (Operation S220), the AVN system may temporarily stop reproduction of the multimedia content (Operation S230). Here, the AVN system may set a buffer according to the type of the content and perform caching up to the capacity of the set buffer until the call is ended.

When the telephone call is ended (Operation S240), the hands-free function may be deactivated and thus, the AVN system may again reproduce the temporarily stopped content from a stoppage point. In reproduction of the temporarily stopped content, if cached content is present, the AVN may first reproduce the cached content.

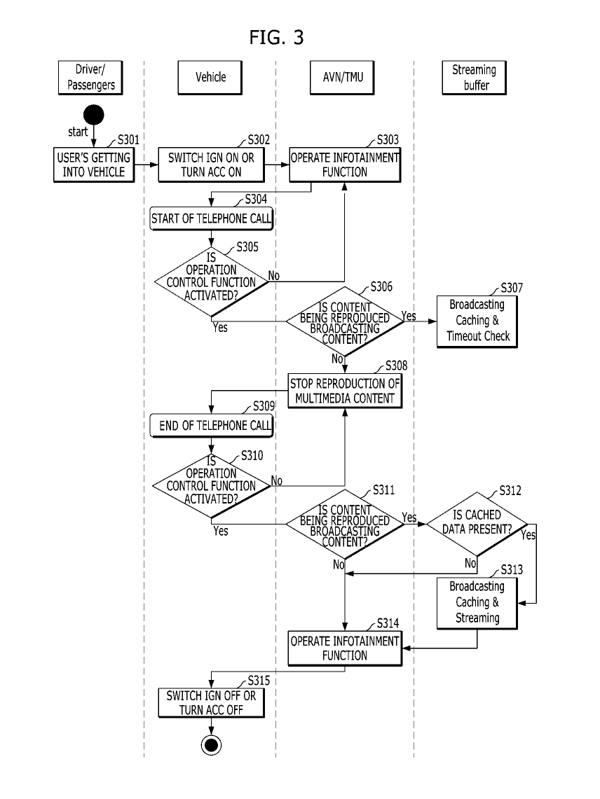

The above-described process shown in FIG. 2 will be described in more detail with reference to FIG. 3.

FIG. 3 is a flowchart exemplarily illustrating, in more detail, a method for controlling multimedia content according to occurrence of a telephone call in an in-vehicle AVN system in accordance with one embodiment of the present disclosure.

In FIG. 3, the above-described function of reproducing content from a portion which is temporarily stopped/cached/stopped will be referred to as an “operation control function” for convenience of description, and it will be assumed that the operation control function may be activated or deactivated according to settings.

With reference to FIG. 3, first, a user possessing a smartphone gets into a vehicle (Operation S301). As the user in the vehicle switches on the ignition of the vehicle (IGN ON) by manipulating a key box or turns on the power of an accessory (Operation S302), power may be supplied to the AVN system and booting of the AVN system may be started. When booting of the AVN system is completed, an infotainment function may be operated, reproduction of content may be started (Operation S303), and pairing of the AVN system with the user's smartphone may be completed.

When a telephone call is started during reproduction of the content (Operation S304), the AVN system may determine whether or not the operation control function is activated (Operation S305) and, upon determining that the operation control function is deactivated, mute output sound while continuing to reproduce the content as in conventional vehicles.

On the other hand, upon determining that the operation control function has been activated, the AVN system confirms the type of the content being reproduced (Operation S306), assigns a buffer and starts caching if the content being reproduced is DMB, radio broadcasting, or content provided in a streaming type (Operation S307). Here, the AVN system may continuously confirm whether or not timeout occurs (i.e., the cached content exceeds the capacity of the buffer) according to the size of the assigned buffer. If the cached content exceeds the capacity of the buffer, the AVN system may delete the entirety of the cached data or continue to perform caching while securing the capacity by sequentially deleting data corresponding to the front portion of the content, according to settings. The case in which the AVN system deletes the entirety of the cached data corresponds to a case in which a designated time or more has elapsed due to the user's long call and thus, resumption of reproduction of the content is insignificant. As described above, in the case of streaming content, a reproduction point of which may be selected, in order to efficiently resume reproduction of the content, an amount of the content for a designated time from a temporary stoppage point may be downloaded in advance and cached.

When caching is started, reproduction of the content may be temporarily stopped (Operation S308). Thereafter, when the telephone call is ended (S309), the AVN system confirms settings (Operation S310), confirms whether or not the temporarily stopped content is broadcasting content (Operation S311), and confirms whether or not cached data is present upon determining that the temporarily stopped content is broadcasting content (Operation S312). Operation S312 is carried out because the entirety of the cached data may be deleted due to timeout, as described above. Upon determining that the temporarily stopped content is not broadcasting content, reproduction of the content may be resumed from the temporary stoppage point (Operation S314).

If cached data is present, the AVN system may continue to cache the currently broadcasting content (Operation 5313) and automatically start reproduction of the content from the beginning of the cached data (Operation S314). The reason why the AVN system continues to cache the content is to continuously provide the content from the temporarily stopped portion to the user in spite of a time difference with actual broadcasting.

On the other hand, if cached data is not present, content which is acquired at present may be reproduced instead of reproduction of the cached data.

If a call is again started after resumption of reproduction of the temporarily stopped content, the AVN system may return to Operation S305 and then repeat the above-described process. Here, if a call is again started under the condition that the entirety of the cached data is not yet reproduced, caching may be carried out subsequently to the cached data which is not yet reproduced.

Thereafter, if the driver switches off the ignition of the vehicle or turns off the power of the accessory, operation of the AVN system may be terminated (Operation S315).

Through the above-described process, although a user gets a telephone call while enjoying content, the user may continuously enjoy the corresponding content after the telephone call without missing a portion of the content due to the telephone call.

The above-described embodiments may be recorded in a computer readable storage medium in which programs are recorded, as computer readable code. Computer readable storage media include all kinds of storage devices in which data readable by a computer system is stored. For example, computer readable media include a hard disk drive (HDD), a solid state disk (SSD), a silicon disk drive (SDD), a ROM, a RAM, a CD-ROM, a magnetic tape, a floppy disk, optical data storage media and the like, and may be implemented in the form of a carrier wave (for example, transmission via the Internet).

As apparent from the above description, at least one embodiment of the present disclosure has effects below.

Since broadcasting content is buffered during a telephone call and the buffered content is immediately reproduced when the call is ended, a user may not miss the content due to the telephone call.

Further, in the case of streaming content, reproduction and streaming of the content are automatically stopped during a telephone call and thus, unnecessary data consumption may be prevented.

It will be apparent to those skilled in the art that various modifications and variations can be made in the present disclosure without departing from the spirit or scope of the invention. Thus, it is intended that the present disclosure covers the modifications and variations of this invention provided they come within the scope of the appended claims and their equivalents.

What is claimed is:

1. A method for controlling reproduction of content in a vehicle comprising:
connecting the vehicle to an external communication terminal;
starting reproduction of the content;
activating the hands-free function of the external communication terminal during reproduction of the content;
performing caching of the content being reproduced according to activation of the hands-free function, until the hands-free function is deactivated;
temporarily stopping reproduction of the content; and
reproducing the cached content when the hands-free function is deactivated.

2. The method according to claim 1, further comprising determining the type of the content,
wherein performance of the caching is carried out if the determined type of the content is a broadcasting type or a type of streaming broadcasting via the Internet.

3. The method according to claim 2, wherein the broadcasting type of the content includes at least one of digital multimedia broadcasting (DMB) or radio broadcasting.

4. The method according to claim 2, wherein, in performance of the caching, if the determined type of the content is streaming content, a reproduction point of which is adjustable, only a predetermined amount of the content is cached.

5. The method according to claim 1, further comprising assigning a buffer of a designated capacity for caching,
wherein performance of the caching includes, if the capacity of the cached content exceeds the capacity of the assigned buffer, deleting the entirety of the cached content.

6. The method according to claim 5, further comprising, if the entirety of the cached content is deleted, directly reproducing content acquired at present while omitting reproduction of the cached content when the hands-free function is deactivated.

7. The method according to claim 1, further comprising assigning a buffer of a designated capacity for caching,
wherein performance of the caching includes, if the capacity of the cached content exceeds the capacity of the assigned buffer, sequentially deleting the front portion of the cached content.

8. The method according to claim 1, wherein the respective operations are carried out through an audio video navigation (AVN) system of the vehicle.

9. An in-vehicle content reproduction system comprising:
a wireless communication unit wirelessly connected to an external communication terminal and configured to transmit/receive hands-free related data; and
a controller configured to, when the hands-free function of the external communication terminal is activated during reproduction of content, perform caching the content being reproduced until the hands-free function is deactivated, temporarily stop reproduction of the content, and reproduce the cached content when the hands-free function is deactivated.

10. The in-vehicle content reproduction system according to claim 9, wherein the controller is configured to determine the type of the content and to perform the caching if the determined type of the content is a broadcasting type or a type of streaming broadcasting via the Internet.

11. The in-vehicle content reproduction system according to claim 10, wherein the broadcasting type of the content includes at least one of digital multimedia broadcasting (DMB) or radio broadcasting.

12. The in-vehicle content reproduction system according to claim 10, wherein the controller is configured to perform caching of only a predetermined amount of the content, if the determined type of the content is streaming content, a reproduction point of which is adjustable.

13. The in-vehicle content reproduction system according to claim 9, further comprising a memory,
wherein the controller is configured to assign a buffer of a designated capacity for caching of the content to the memory and, if the capacity of the cached content exceeds the capacity of the assigned buffer, to delete the entirety of the cached content.

14. The in-vehicle content reproduction system according to claim 13, wherein the controller is configured to, if the entirety of the cached content is deleted, omit reproduction of the cached content and directly reproduce content acquired at present when the hands-free function is deactivated.

15. The in-vehicle content reproduction system according to claim 9, further comprising a memory,
wherein the controller is configured to assign a buffer of a designated capacity for caching of the content to the memory and, if the capacity of the cached content exceeds the capacity of the assigned buffer, to sequentially delete the front portion of the cached content.

16. The in-vehicle content reproduction system according to claim 9, wherein the in-vehicle content reproduction system includes an audio video navigation (AVN) system.
